(19) United States
(12) Patent Application Publication
(10) Pub. No.: US 2013/0244660 A1
(43) Pub. Date: Sep. 19, 2013

(54) MITIGATING PAGING COLLISION FOR DUAL-CAMPED SINGLE RADIO RECEIVERS

(71) Applicant: QUALCOMM INCORPORATED, San Diego, CA (US)

(72) Inventors: Vanitha Aravamudhan Kumar, San Diego, CA (US); Arvind Swaminathan, San Diego, CA (US); Srinivasan Balasubramanian, San Diego, CA (US); Thomas Klingenbrunn, San Diego, CA (US)

(73) Assignee: QUALCOMM INCORPORATED, San Diego, CA (US)

(21) Appl. No.: 13/827,416

(22) Filed: Mar. 14, 2013

Related U.S. Application Data
(60) Provisional application No. 61/612,110, filed on Mar. 16, 2012.

(51) Int. Cl. H04W 36/16

(52) U.S. Cl. CPC H04W 36/165
USPC 455/436

(57) ABSTRACT

Aspects of the present disclosure generally relate to wireless communication and to handling paging cycle overlaps by a dual camped UE. According to an aspect, a UE may detect a paging occasion of a cell in the first RAT and a paging occasion of a cell in a second RAT, and camp on a third RAT upon determining that the paging occasions overlap. Prior to camping on the third RAT, according to aspects, the UE may perform a cell reselection in the first RAT after determining that the paging occasions of the first and second RATs overlap, detect a paging occasion of the reselected cell in the first RAT, and camp on the third RAT when the paging occasion of the reselected cell in the first RAT and the paging occasion of the second RAT overlap.

### CROSS-REFERENCE TO RELATED APPLICATIONS

This application claims benefit of priority to U.S. Provisional Application Ser. No. 61/612,110, filed on Mar. 16, 2012, which is expressly incorporated by reference herein in its entirety.

### BACKGROUND

1. Field

Aspects of the present disclosure relate generally to wireless communication systems, and more particularly to mitigating paging collisions when a single radio receiver is camped on two radio access technologies.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method for wireless communication performed by a user equipment (UE). The method generally includes camping on a cell in a first radio access technology (RAT), detecting a paging occasion of the cell in the first RAT and a paging occasion of a cell in a second RAT, and camping on a third RAT upon determining that the paging occasions overlap.

Certain aspects of the present disclosure provide an apparatus for wireless communication by a UE. The apparatus generally includes means for camping on a cell in a first radio access technology (RAT), means for detecting a paging occasion of the cell in the first RAT and a paging occasion of a cell in a second RAT, and means for camping on a third RAT upon determining that the paging occasions overlap.

Certain aspects of the present disclosure provide an apparatus for wireless communication by a UE. The apparatus generally includes at least one processor and a memory coupled to the at least one processor. The at least one processor is generally configured to camp on a cell in a first radio access technology (RAT), detect a paging occasion of the cell in the first RAT and a paging occasion of a cell in a second RAT, and camp on a third RAT upon determining that the paging occasions overlap.

Certain aspects of the present disclosure provide a computer-program product for wireless communication by a UE. The computer-program product generally includes a non-transitory computer-readable medium having code stored thereon. The code is generally executable by one or more processors for camping on a cell in a first radio access technology (RAT), detecting a paging occasion of the cell in the first RAT and a paging occasion of a cell in a second RAT, and camping on a third RAT upon determining that the paging occasions overlap.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture, according to aspects of the present disclosure.

FIG. 2 is a diagram illustrating an example of an access network, according to aspects of the present disclosure.

FIG. 3 is a diagram illustrating an example of a downlink frame structure in LTE, according to aspects of the present disclosure.

FIG. 4 is a diagram illustrating an example of an uplink frame structure in LTE, according to aspects of the present disclosure.

FIG. 5 is a diagram illustrating an example of an evolved Node B and user equipment in an access network, according to aspects of the present disclosure.

FIG. 6 is a diagram illustrating paging overlap, according to aspects of the present disclosure.

FIG. 7 is a diagram illustrating, according to aspects of the present disclosure.

FIGS. 8A-8B are flow charts illustrating methods for mitigating page loss, according to aspects of the present disclosure.

FIGS. 9A-9B illustrate example operations performed, for example, by a UE for mitigating page loss according to aspects of the present disclosure.

FIG. 10 is a diagram illustrating an example of a hardware implementation for an apparatus employing a method for mitigating page loss, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the telecommunication systems are presented with reference to various apparatus and methods. These apparatus and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

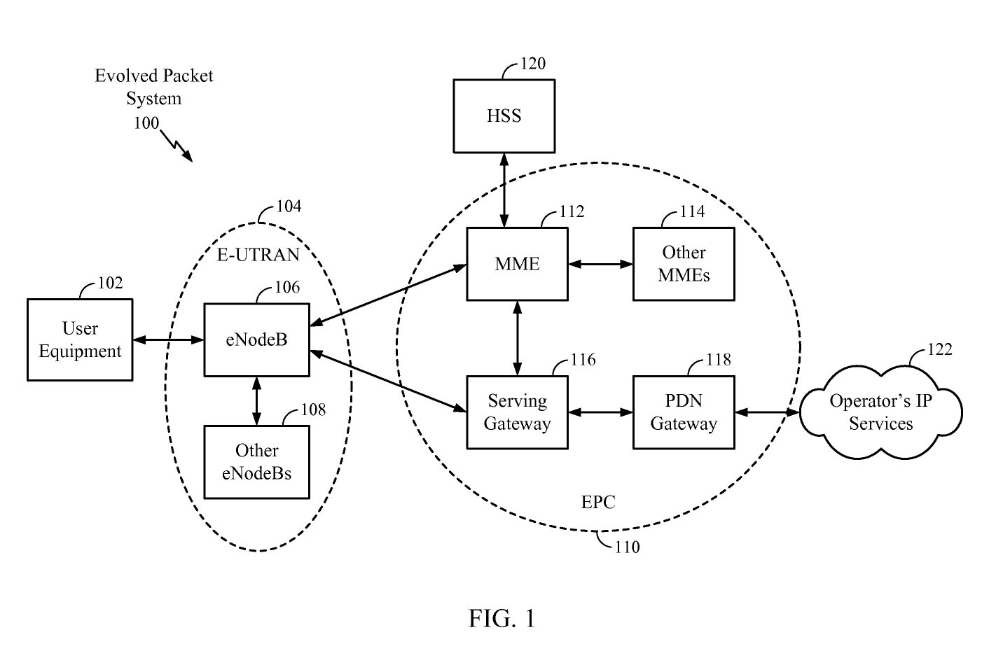

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNodeB) 106 and other eNodeBs 108. The eNodeB 106 provides user and control plane protocol terminations toward the UE 102. The eNodeB 106 may be connected to the other eNodeBs 108 via an X2 interface (e.g., backhaul). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

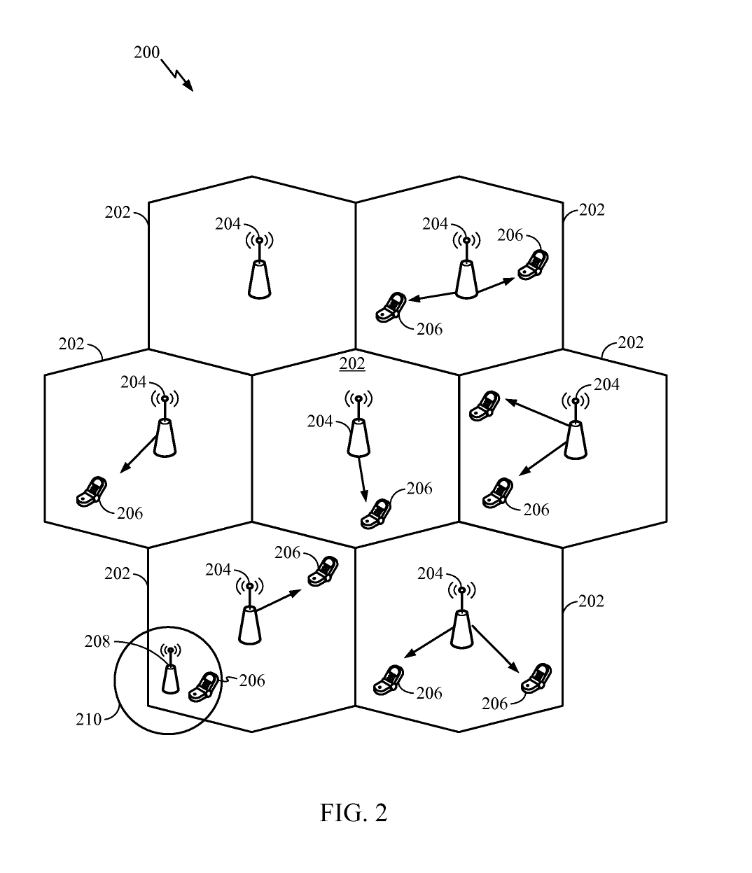

FIG. 2 is a diagram illustrating an example of an access network 200 in an LTE network architecture. In this example, the access network 200 is divided into a number of cellular regions (cells) 202. One or more lower power class eNodeBs 208 may have cellular regions 210 that overlap with one or more of the cells 202. A lower power class eNodeB 208 may be referred to as a remote radio head (RRH). The lower power class eNodeB 208 may be a femto cell (e.g., home eNodeB (HeNodeB)), pico cell, or micro cell. The macro eNodeBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNodeBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the downlink and SC-FDMA is used on the uplink to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNodeBs 204 may have multiple antennas supporting MIMO technology. The use of MIMO technology enables the eNodeBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 206 with different spatial signatures, which enables each of the UE(s) 206 to recover the one or more data streams destined for that UE 206. On the uplink, each UE 206 transmits a spatially precoded data stream, which enables the eNodeB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PAPR).

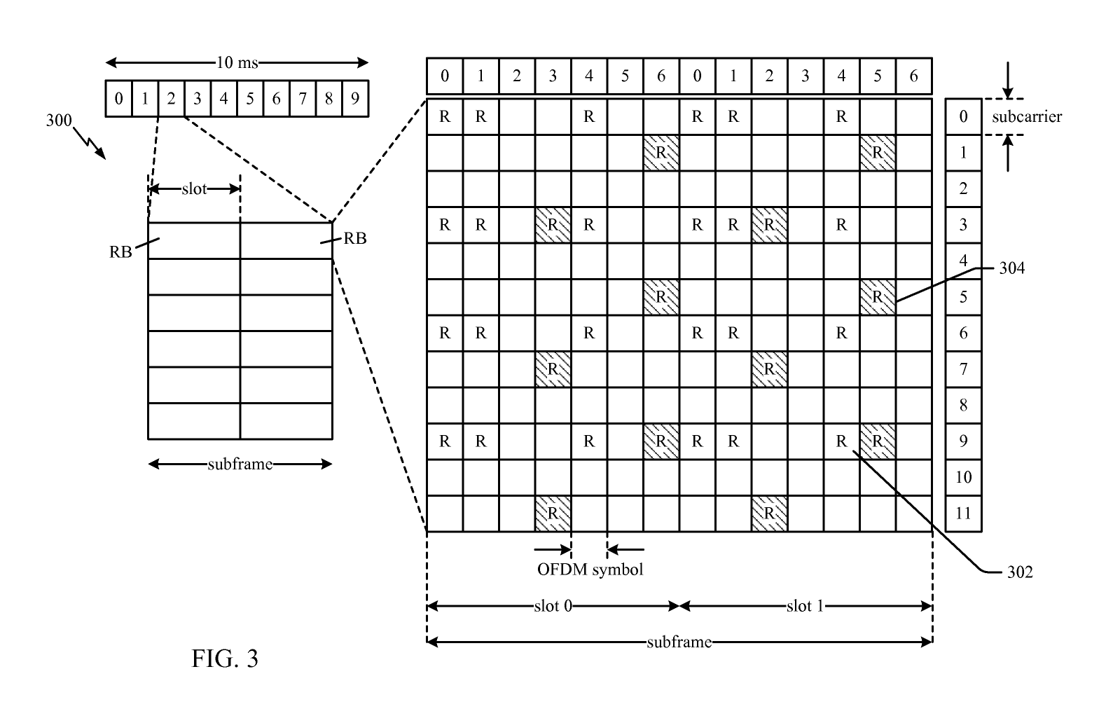

FIG. 3 is a diagram 300 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include downlink reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

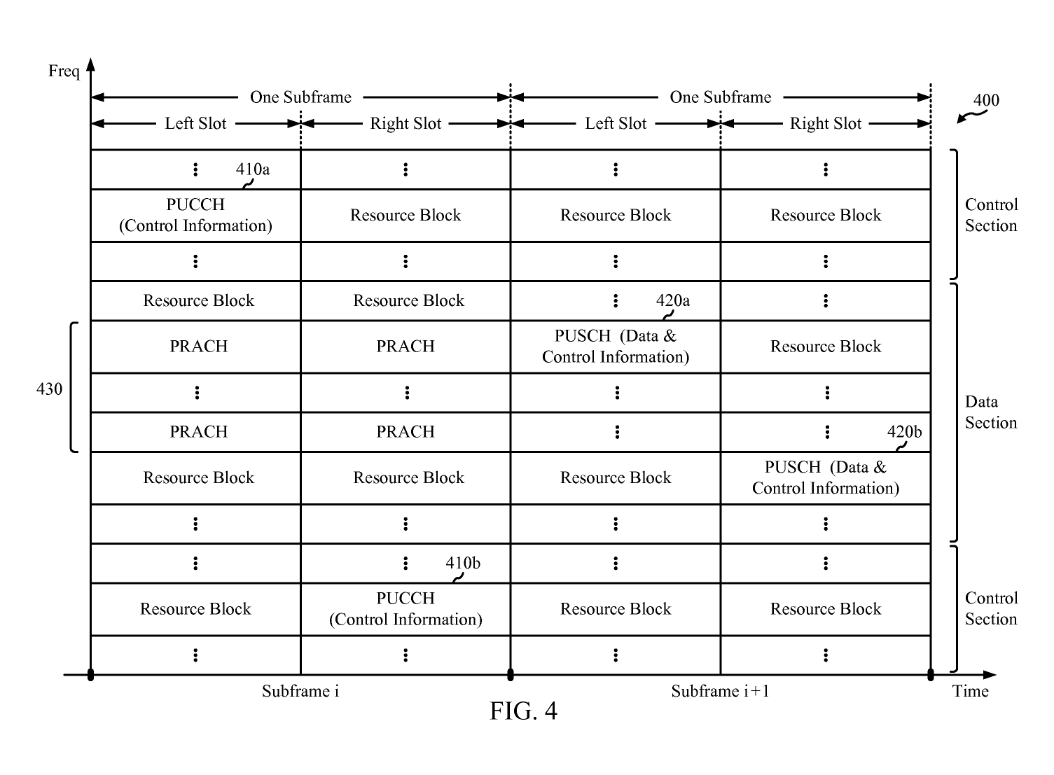

FIG. 4 is a diagram 400 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 410a, 410b in the control section to transmit control information to an eNodeB. The UE may also be assigned resource blocks 420a, 420b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. A uplink transmission may span both slots of a subframe and may hop across frequency.

A set of resource blocks may be used to perform initial system access and achieve uplink synchronization in a physical random access channel (PRACH) 430. The PRACH 430 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

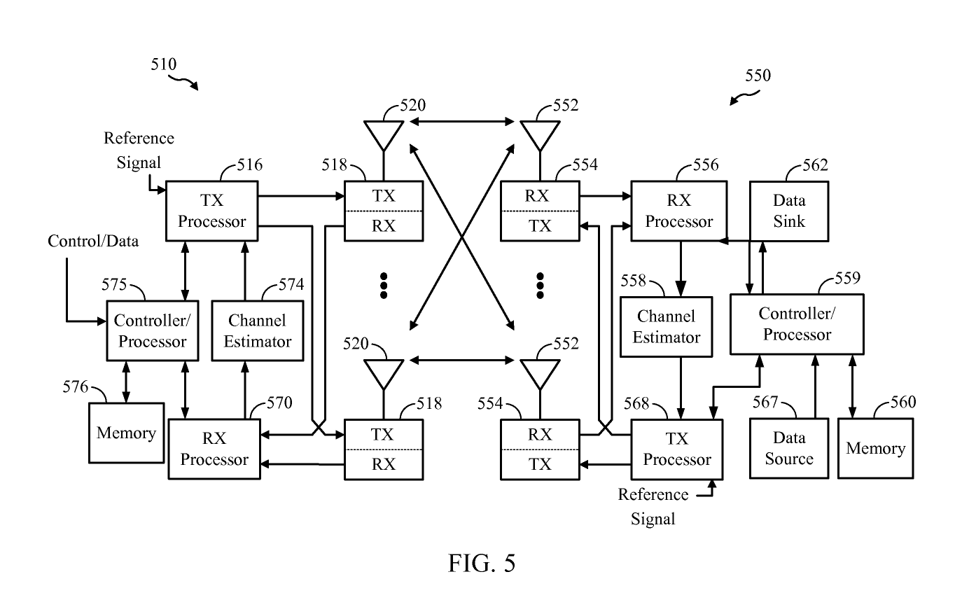

FIG. 5 is a block diagram of an eNodeB 510 in communication with a UE 550 in an access network. In the downlink, upper layer packets from the core network are provided to a controller/processor 575. The controller/processor 575 implements the functionality of the L2 layer. In the downlink, the controller/processor 575 provides header compression, ciphering, packet segmentation and reordering, multiplexing between logical and transport channels, and radio resource allocations to the UE 550 based on various priority metrics. The controller/processor 575 is also responsible for HARQ operations, retransmission of lost packets, and signaling to the UE 550.

The TX processor 516 implements various signal processing functions for the L1 layer (i.e., physical layer). The signal processing functions includes coding and interleaving to facilitate forward error correction (FEC) at the UE 550 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the UE 550. Each spatial stream is then provided to a different antenna 520 via a separate transmitter 518TX. Each transmitter 518TX modulates an RF carrier with a respective spatial stream for transmission.

At the UE 550, each receiver 554RX receives a signal through its respective antenna 552. Each receiver 554RX recovers information modulated onto an RF carrier and provides the information to the receiver (RX) processor 556. The RX processor 556 implements various signal processing functions of the L1 layer. The RX processor 556 performs spatial processing on the information to recover any spatial streams destined for the UE 550. If multiple spatial streams are destined for the UE 550, they may be combined by the RX processor 556 into a single OFDM symbol stream. The RX processor 556 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNodeB 510. These soft decisions may be based on channel estimates computed by the channel estimator 558. The soft decisions are then decoded and deinterleaved to recover the data and control signals that were originally transmitted by the eNodeB 510 on the physical channel. The data and control signals are then provided to the controller/processor 559.

The controller/processor 559 implements the L2 layer. The controller/processor can be associated with a memory 560 that stores program codes and data. The memory 560 may be referred to as a computer-readable medium. In the uplink, the control/processor 559 provides demultiplexing between transport and logical channels, packet reassembly, deciphering, header decompression, control signal processing to recover upper layer packets from the core network. The upper layer packets are then provided to a data sink 562, which represents all the protocol layers above the L2 layer. Various control signals may also be provided to the data sink 562 for L3 processing. The controller/processor 559 is also responsible for error detection using an acknowledgement (ACK) and/or negative acknowledgement (NACK) protocol to support HARQ operations.

In the uplink, a data source 567 is used to provide upper layer packets to the controller/processor 559. The data source 567 represents all protocol layers above the L2 layer. Similar to the functionality described in connection with the downlink transmission by the eNodeB 510, the controller/processor 559 implements the L2 layer for the user plane and the control plane by providing header compression, ciphering, packet segmentation and reordering, and multiplexing between logical and transport channels based on radio resource allocations by the eNodeB 510. The controller/processor 559 is also responsible for HARQ operations, retransmission of lost packets, and signaling to the eNodeB 510.

Channel estimates derived by a channel estimator 558 from a reference signal or feedback transmitted by the eNodeB 510 may be used by the TX processor 568 to select the appropriate coding and modulation schemes, and to facilitate spatial processing. The spatial streams generated by the TX processor 568 are provided to different antenna 552 via separate transmitters 554TX. Each transmitter 554TX modulates an RF carrier with a respective spatial stream for transmission.

The uplink transmission is processed at the eNodeB 510 in a manner similar to that described in connection with the receiver function at the UE 550. Each receiver 518RX receives a signal through its respective antenna 520. Each receiver 518RX recovers information modulated onto an RF carrier and provides the information to a RX processor 570. The RX processor 570 may implement the L1 layer.

The controller/processor 575 implements the L2 layer. The controller/processor 575 can be associated with a memory 576 that stores program codes and data. The memory 576 may be referred to as a computer-readable medium. In the uplink, the control/processor 575 provides demultiplexing between transport and logical channels, packet reassembly, deciphering, header decompression, control signal processing to recover upper layer packets from the UE 550. Upper layer packets from the controller/processor 575 may be provided to the core network. The controller/processor 575 is also responsible for error detection using an ACK and/or NACK protocol to support HARQ operations.

### Mitigating Paging Collision of a Dual Camped Single Radio Receiver

A mobile communication device, such as a wireless device 550, can be camped and registered with two different radio access technologies (RATs) at the same time (i.e., dual-camped). For example, the device 550 can be registered on LTE for packet switched (PS) services, and registered on single carrier radio transmission technology (e.g., 1xRTT) for circuit switched (CS) services.

A dual-camped device may listen to the paging channels of both radio technologies in order to be notified about an incoming call from the network. Examples of RATs include, e.g., Universal Mobile Telecommunications System (UMTS), Global System for Mobile Communications (GSM), cdma2000, WiMAX, WLAN (e.g., WiFi), Bluetooth, LTE, and the like.

A dual-camped device may act as a single radio device or dual radio device, depending on the number of radio receivers on the device which simultaneously receive a signal from a RAT. A single radio device receives a signal from only one RAT at a time whereas a dual-camped device with a single radio may be configured to tune back and forth between two RATs to receive the paging channel from both RATs using the single radio. By moving back and forth between two RATs, as described in more detail below, mobile device may miss paging occasions. Aspects of the present discourse provide techniques to mitigate this problem.

A paging occasion refers to the time period during which a wireless device listens to a paging channel. The paging occasion is determined by the network at the time of camping when the system broadcast information is read. A paging cycle refers to the periodicity at which the paging occasion occurs.

When a wireless device is camped on a first RAT, for example RATa, it may tune away from RATa to a second RAT, for example RATb, for a period of time t to monitor for pages on RATb. If the paging occasion of RATa occurs during time t the wireless device will miss pages on RATa.

In another example, when the paging cycles of RATa and RATb are the same, and if the paging occasion occurs during the duration of time t, the paging occasions for the two RATs will always overlap (the collision rate is 100%). Thus, the wireless device 550 will not receive a page in RATa because it will prioritize RATb.

If the paging cycle of RATa is a whole number multiple of the paging cycle of RATb and the paging occasion occurs during the time period t, the collision rate is still 100%. If the paging cycle of RATb is a whole number multiple (e.g., n) of the paging cycle of RATa, the wireless device 550 may not miss 100% of the pages of RATa, but rather the pages may be significantly degraded based on the value of n.

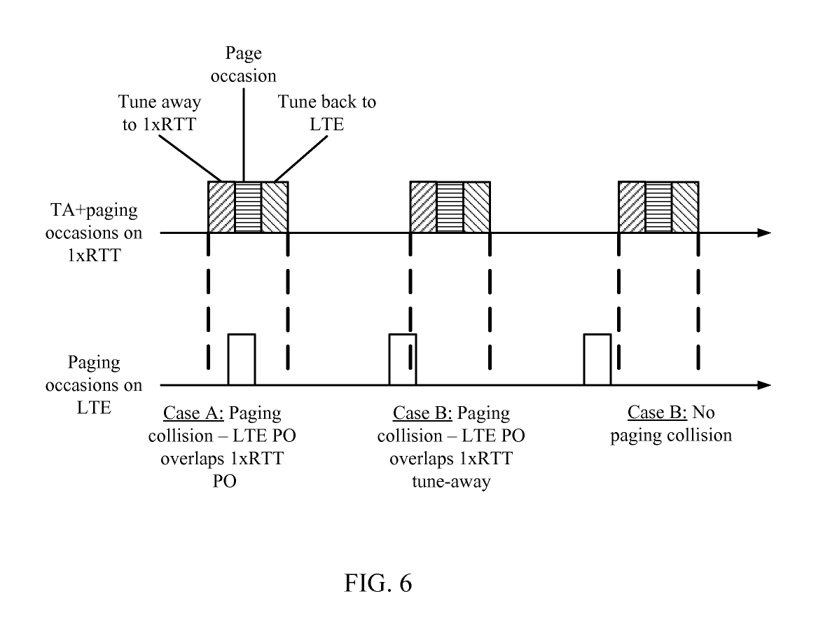

FIG. 6 illustrates an example of paging overlap, according to aspects of the present disclosure. In case A, the LTE paging occasion overlaps the 1xRTT paging occasion. In case B, the LTE paging occasion does not overlap the 1xRTT paging occasion. However, in case B, due to the tune-away time, the UE may not be able to decode pages in both LTE and 1x. To be able to decode both pages, as shown in case C, the LTE paging occasion is completely clear of (1) the time interval needed for 1xRTT tune-away, (2) 1xRTT paging occasion, and (3) tuning back to LTE.

Aspects of the present disclosure are directed to avoiding page loss where paging occasions collide, by a UE temporarily switching to another RAT until the paging overlap no longer exists.

As will be described in more detail below, after the UE detects paging overlap in the first and second RATs, the UE may perform a cell reselection in the first RAT. This cell reselection may be performed prior to camping on the third RAT. After performing a cell reselection in the first RAT, the UE may detect a paging occasion of the reselected cell. The UE may camp on the third RAT when the paging occasions of the reselected cell in the first RAT and the paging occasion of the second RAT overlap.

In an aspect of the present disclosure, a single radio receiver monitors two different RATs. The device is configured to identify a paging occasion overlap between a first and second RAT (RATa and RATb, respectively) and determine whether to leave RATa to receive service on a third RAT (RATc). When the paging occasions of RATa and/or RATb change, the device reevaluates whether to stay on RATc or return to RATa.

In one example, a wireless device 550 is camped on a RATa and tunes periodically to monitor pages on a RATb. The time the wireless device 550 is away from RATa is time t. The paging cycle of RATb divided by the paging cycle of RATa is denoted by the value of n which indicates paging performance. According to aspects of the present disclosure, paging performance for various values is indicated as follows:

If n=1, then if the paging occasion in RATa (POa) occurs during time t, the paging miss rate on RATa is 100%.

If n<1, then the wireless device tunes to RATb multiple times during one paging cycle of RATa. If the POa occurs during time t, the page miss on RATa is 100%.

If n>1, the wireless device tunes to RATb once every n paging cycles of RATa. The page performance is degraded as the wireless device may miss a page in RATa once every n pages if the POa occurs during time t. The smaller the value of the paging performance n then the higher the degradation.

According to aspects of the present disclosure, when the wireless device 550 determines that the POa occurs during the tune away duration t every n paging cycles of RATa, the device determines whether one of the following conditions are satisfied:
a) if n<=1, where n is the paging cycle of RATb divided by the paging cycle of RATa; or
b) if n<threshold (where the threshold is a configured value in the device).

If one of the above conditions is satisfied, the wireless device 550 may determine that service on RATa will be too degraded to remain with the current cell of RATa. As will be described in more detail below, the wireless device 550 may locate a different cell on RATa to camp on where the above condition is not satisfied or the wireless device 550 may locate a different RAT other than RATa to camp on in an effort to receive improved service.

If the wireless device locates and camps on a different RAT (e.g., RATc), it may optionally determine whether an opportunity exists to return back to RATa without the paging occasion being degraded. Optionally, the device may check at various, repeated intervals to determine if it can return to RATa.

According to one example, the wireless device 550 is dual camped on Long Term Evolution (LTE) network and 1xRTT. If the wireless device detects that the paging occasions overlap, it may leave LTE and register for PS services on a high rate packet data (HRPD) or evolved high rate packet data (eHRPD) network service. Later, when LTE and 1xRTT paging occasions no longer overlap, the wireless device may return to LTE and reregister for PS services.

In LTE/UMTS, the paging occasion is a function of the unique device identifier (e.g., international mobile subscriber identity (IMSI)), the number of paging channels (e.g., secondary common control physical channel (SCCPCH)), and the system frame number (SFN) which refers to the timing of the cell (eNodeB) on which the wireless device is camped. The IMSI is constant, and the number of SCCPCH may remain the same across the entire network. The SFN typically varies from cell to cell because each base station maintains its own timing. Thus a serving cell change event on LTE may change the paging occasion and be a trigger to return to LTE.

The wireless device may return to LTE via various mechanisms and/or triggers. For example, when the wireless device detects the paging occasion on 1xRTT and/or LTE has changed, the wireless device may return to LTE. Additionally, when the wireless device is camped on eHRPD, the wireless device may monitor LTE and check whether a suitable cell with a non-overlapping paging occasion is available. This may be determined by reading the broadcast channel (MIB) of the candidate cell, which carries the SFN of the cell. Once it is determined that the paging occasions no longer overlap, the wireless device may return to LTE.

If there are no opportunities to tune to LTE, then during active eHRPD data transfer, mobility on eHRPD (i.e. serving cell change) may trigger the wireless device to return to LTE.

According to aspects, the release of the radio connection may trigger the wireless device to return to back to LTE. Additionally, a timer based mechanism may trigger the wireless device to return to LTE.

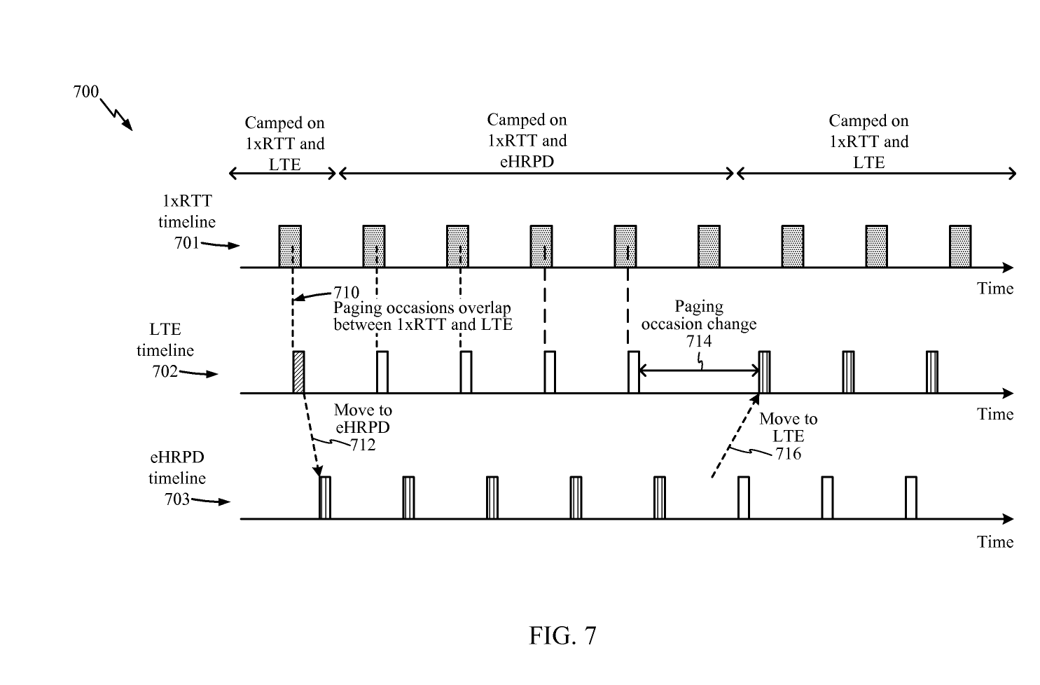

FIG. 7 illustrates example timelines 700 for paging occasions, according to aspects of the present disclosure. Timeline 701 illustrates a timeline paging occasion on 1xRTT where the paging occasions include the time needed for tune-away and tune-back. Timelines 702 and 703 illustrate paging occasions on LTE and eHRPD, respectively. At 710, a mobile device is dual camped on LTE and 1xRTT, and the device determines that the paging occasions between LTE and 1xRTT overlap. At 712, the device leaves LTE and camps on eHRPD, where the paging occasions do not overlap with 1xRTT. At 714, the paging occasion on LTE changes. At 716, the device detects that the paging occasions on LTE and 1xRTT no longer overlap. Accordingly, the mobile device leaves eHRPD and returns to LTE.

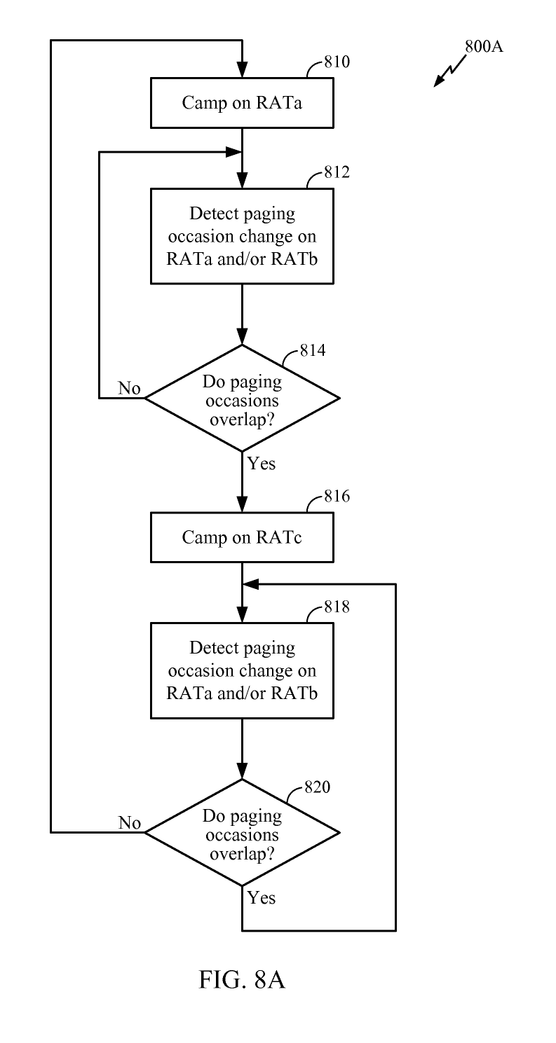

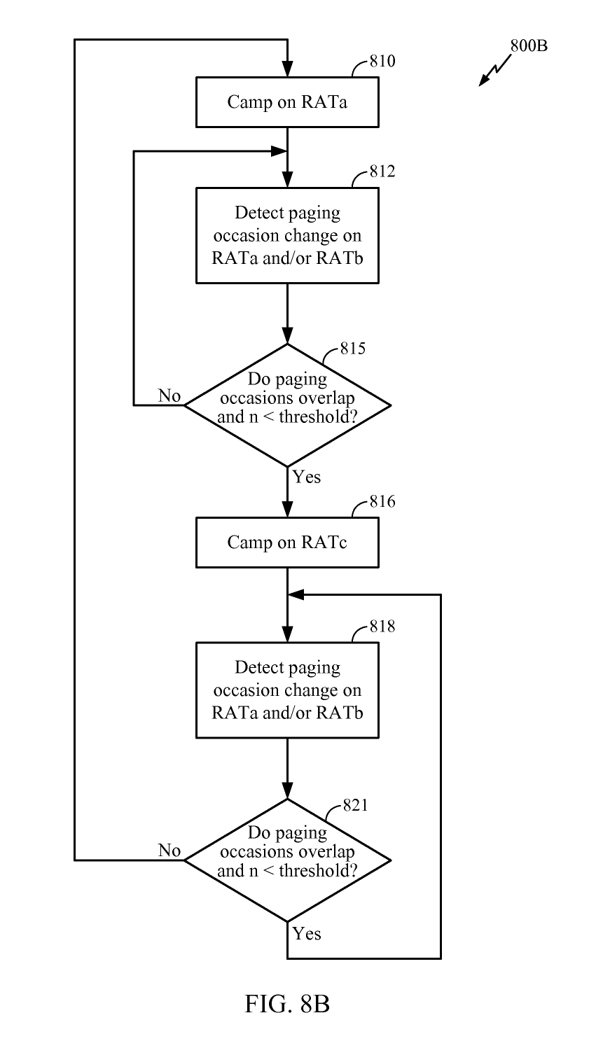

FIGS. 8A-8B illustrate flow charts of example processes 800A and 800B for determining paging overlap, according to aspects of the present disclosure. In FIG. 8A, at 810, a wireless device camps on RATa. Next, at 812, the device detects a paging occasion change on RATa and/or RATb. At 814, the device determines whether the paging occasions on RATa and RATb overlap. If the paging occasions do not overlap, the process returns to 812, where the device checks for a paging occasion change on RATa and/or RATb.

If, at 814, the device determines that the paging occasions on RATa and RATb overlap, then, at 816, the device leaves RATa and camps on RATc. Next, at 818, the device detects a paging occasion change on RATa and/or RATb. At 820, the device determines whether the paging occasions on RATa and/or RATb overlap. If the paging occasions on RATa and RATb overlap, the device continues to camp on RATc and waits to detect a paging occasion change on RATa and/or RATb. If, at 820, the device determines the paging occasions on RATa and RATb do not overlap, the device camps on RATa (at 810).

FIG. 8B illustrates a variation of FIG. 8A, where a parameter n is taken into account when determining whether to leave RATa, according to aspects of the present disclosure. In particular, at 810, the device is camped on RATa. At 812, the device detects a paging occasion change on RATa and/or RATb. At 815, the device determines if the paging occasions overlap, as illustrated in FIG. 8, and if n is less than a threshold value. If so, at 816, the device leaves RATa and camps on RATc.

While camped on RATc, at 818, the device may detect a paging occasion change on RATa and/or RATb. If, at 821, the paging occasions of RATa and RATb overlap and n is less than a predetermined threshold value, the device continues to camp on RATc. Otherwise, the device may return to camp on RATa.

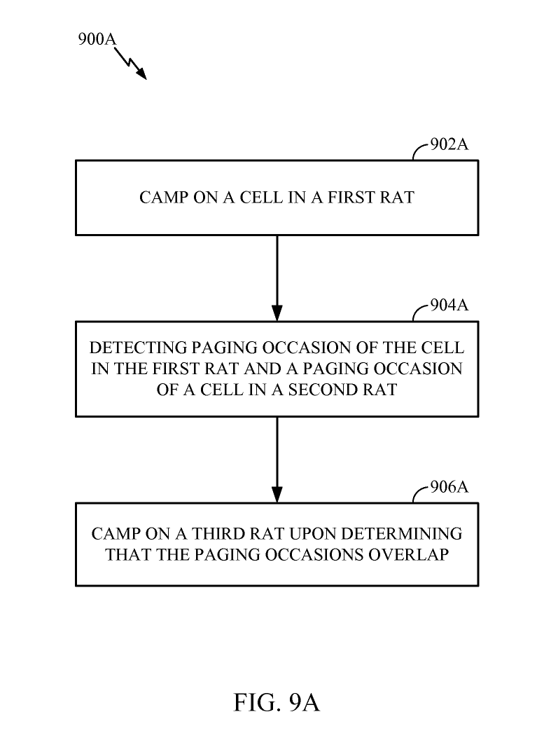

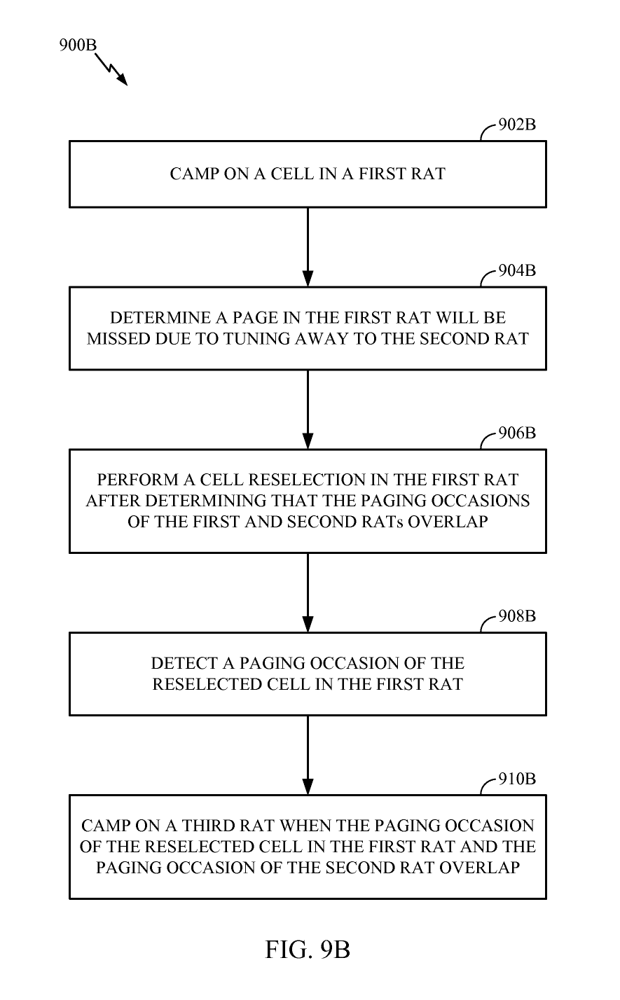

FIG. 9A illustrates an example method 900A for mitigating paging loss, according to aspects of the present disclosure. The method may be performed by a UE, for example UE 102 of FIG. 1 or UE 550 of FIG. 5.

At 902A, the UE camps on a cell in a first radio access technology (RAT). At 904A, the UE detects a paging occasion of the cell in the first RAT and a paging occasion of a cell in a second RAT. At 906A, the UE camps on a third RAT upon determining that the paging occasions overlap.

As described above, the UE may detect a paging occasion change on at least one of the cell in the first RAT and the cell in the second RAT while camping on the third RAT. The device may return to the first RAT after determining the paging occasions of the first and second RATs do not overlap.

According to aspects, the UE may determine a paging cycle value of the first RAT and the second RAT and may camp on the third RAT when the paging cycle value is less than a threshold value. The UE may return to camping on the first RAT based on a trigger. The trigger may be, for example, a timer, a release of a radio connection, or a serving cell change.

FIG. 9B illustrates an example method 900B for handling paging overlaps between a first and second RAT according to aspects of the present disclosure. The method may be performed by a UE, for example UE 102 of FIG. 1 or UE 550 of FIG. 5. The method of FIG. 9B provides techniques to handle paging overlaps in a first a second RAT prior to camping on a third RAT.

At 902B, the UE camps on a cell in a first RAT. Next, UE determines that the paging occasions of the first and second RATs overlap by determining that a page in the first RAT will be missed. Pages in the first RAT may be missed due to paging overlap between the first and second RAT including tuning away and tune back time. For example, at 904, the UE may determine that a page in the first RAT will be missed due to tuning away to the second RAT.

At 906B, the UE performs a cell reselection in the first RAT. At 908B, the UE proceeds to detect a paging occasion of the reselected cell in the first RAT. At 910B, the UE camps on a third RAT when the paging occasion of the reselected cell in the first RAT and the paging occasion of the second RAT overlap.

According to aspects, a UE may be idle on a first RAT (e.g., LTE) and a second RAT (e.g., 1xRTT). Since LTE and 1x networks may not have coordination, LTE paging (discontinuous transmission (DRX)) wakeups may coincide with 1x paging wakeups. As described in more detail with respect to FIG. 6, mechanisms to handle paging overlaps between two RATs account for warm up activities prior to page reception including tune-away and tune-back.

When a paging occasion in a first RAT (e.g., an LTE paging wake up) is missed, for example, due to tuning away to a second RAT (e.g., 1x), a device may return to the first RAT after tune-away and perform a cell reselection evaluation in the first RAT.

If the device detects a paging cycle overlap between the first and second RATs, the UE may perform a cell reselection to select a neighboring cell in the first RAT. If the first RAT is an LTE network, when a paging cycle overlap is detected in the nearest LTE cell, the UE may reselect another neighboring cell with an overlapping footprint.

When a co-channel LTE cell is not available, but another LTE frequency or band of operation is available that is from the same Public Land Mobile Network (PLMN) or an equivalent PLMN, the device may reselect a cell from another LTE frequency or band.

If another cell on LTE is not available, the device may enter a data optimized (DO) mode when a ratio between paging cycles on 1x to LTE exceeds a threshold. According to aspects, different events may be used to trigger the device's return to LTE. Example of triggers include device mobility detection, DO connection release, timer based triggers, and/or a change of paging occasions on 1x. Thus, prior to camping on a third RAT, a device may prioritize pages in the first RAT over pages in the second RAT based on downlink traffic.

According to aspects, a device may reduce tune-away to the second RAT using a connected mode discontinuous reception (DRX) intervals and/or connected mode gaps on the first RAT for non-page reception activities in the second RAT.

As described herein, aspects of the present disclosure provide techniques to mitigate a dual-camped UE missing pages in one or more RATs. According to an aspect, a UE dual camped on a first and second RAT may leave the first RAT and camp on a third RAT upon determining that a page in the first RAT will be missed due to tuning away to the second RAT.

Prior to camping on the third RAT, the UE may perform a cell reselection in the first RAT. Then, the UE may detect a paging occasion of the reselected cell in the first RAT. The UE may camp on the third RAT when the paging occasion of the reselected cell in the first RAT and the paging occasion of the second RAT overlap.

In one configuration, a UE 550 is configured for wireless communication including means for camping on a RAT. In one aspect, the camping means may be the controller/processor 559 and/or memory 660 configured to perform the functions recited by the camping means. The UE 550 also includes a detecting means. The detecting means may be the controller/processor 559 and/or memory 660 configured to perform the functions recited by the detecting means. In another aspect, the aforementioned means may be any module or any apparatus configured to perform the functions recited by the aforementioned means.

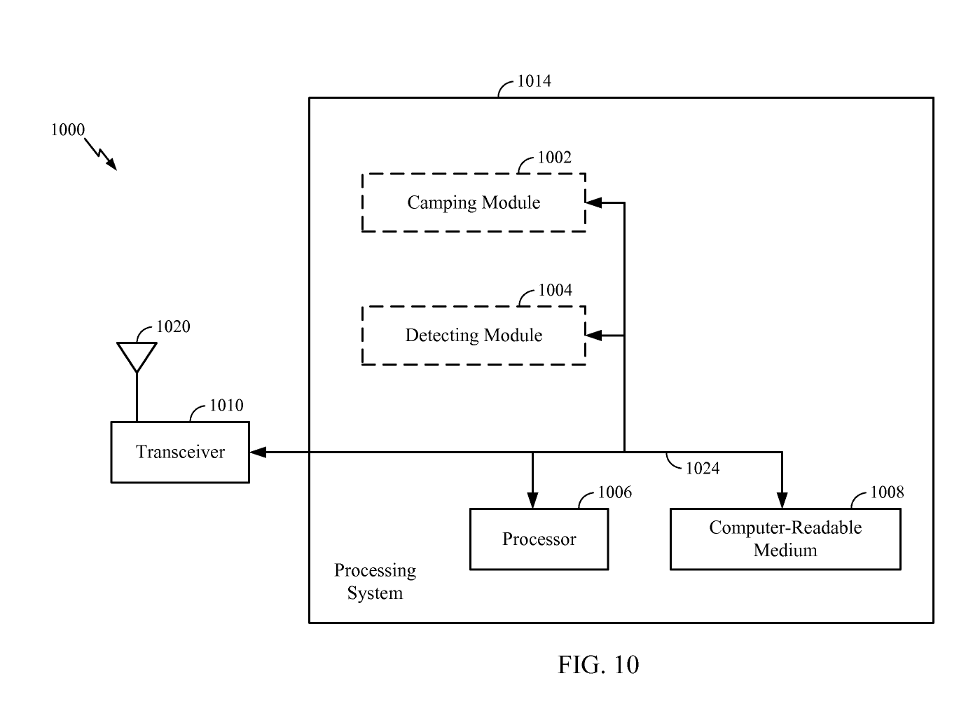

FIG. 10 is a diagram illustrating an example of a hardware implementation for an apparatus 1000 employing a processing system 1014 configured to mitigate paging loss. The system 1014 may be implemented with a bus architecture, represented generally by a bus 1024. The bus 1024 may include any number of interconnecting buses and bridges depending on the specific application of the system 1014 and the overall design constraints. The bus 1024 links together various circuits including one or more processors and/or hardware modules, represented by a processor 1006, a camping module 1002, a detecting module 1004, and a computer-readable medium 1008. The bus 1024 may also link various other circuits such as timing sources, peripherals, voltage regulators, and power management circuits, which are well known in the art, and therefore, will not be described any further.

The apparatus includes the system 1014 coupled to a transceiver 1010. The transceiver 1010 is coupled to one or more antennas 1020. The transceiver 1010 provides a means for communicating with various other apparatus over a transmission medium. The system 1014 includes the processor 1006 coupled to the computer-readable medium 1008. The processor 1006 is responsible for general processing, including the execution of software stored on the computer-readable medium 1008. The software, when executed by the processor 1006, causes the system 1014 to perform the various functions described supra for any particular apparatus.

The computer-readable medium 1008 may also be used for storing data that is manipulated by the processor 1006 when executing software. The system 1014 further includes the camping module 1002 for camping on RATs, and the detecting module 1004 for detecting paging occasions. The camping module 1002 and the detecting module 1004 may be software modules running in the processor 1006, resident/stored in the computer readable medium 1008, one or more hardware modules coupled to the processor 1006, or some combination thereof. The system 1014 may be a component of the UE 550 and may include the memory 560 and/or the processor controller/processor 559.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), comprising:
camping on a cell in a first radio access technology (RAT);
detecting a paging occasion of the cell in the first RAT and a paging occasion of a cell in a second RAT; and
camping on a third RAT upon determining that the paging occasions overlap.

2. The method of claim 1, further comprising:
detecting a paging occasion change on at least one of the cell in the first RAT and the cell in the second RAT while camping on the third RAT.

3. The method of claim 2, further comprising:
returning to the first RAT after determining the paging occasions of the first and second RATs do not overlap.

4. The method of claim 1, further comprising:
determining a paging cycle value of the first RAT and the second RAT; and
camping on the third RAT when the paging cycle value is less than a threshold value.

5. The method of claim 1, further comprising:
returning to camping on the first RAT based on a trigger, in which the trigger is one of a timer, a release of a radio connection, and a serving cell change.

6. The method of claim 1, wherein determining that the paging occasions of the first and second RATs overlap comprises:
determining a page in the first RAT will be missed due to tuning away to the second RAT.

7. The method of claim 6, further comprising:
performing a cell reselection in the first RAT after determining that the paging occasions of the first and second RATs overlap;
detecting a paging occasion of the reselected cell in the first RAT; and
camping on the third RAT when the paging occasion of the reselected cell in the first RAT and the paging occasion of the second RAT overlap.

8. The method of claim 7, wherein the cell reselection selects a neighboring cell in the first RAT.

9. The method of claim 7, wherein the cell reselection selects a cell from one of a same Public Land Mobile Network (PLMN) or an equivalent PLMN as the cell in the first RAT.

10. The method of claim 7, further comprising:
entering a data optimized (DO) mode when another cell on the first RAT is not available and a ratio between paging cycles of the first and second RATs exceeds a threshold.

11. The method of claim 1, further comprising:
prioritizing pages in the first RAT over pages in the second RAT based on downlink traffic.

12. The method of claim 6, further comprising:
reducing tune-away to the second RAT using at least one of connected mode discontinuous reception (DRX) intervals and connected mode gaps on the first RAT for non-page reception activities in the second RAT.

13. The method of claim 1, wherein the first RAT is a Long Term Evolution (LTE) network and the second RAT is a 1x network.

14. The method of claim 13, wherein the third RAT is an evolved High Rate Packet Data (eHRPD) network.

15. An apparatus for communication performed by a user equipment (UE), comprising:
means for camping on a cell in a first radio access technology (RAT);
means for detecting a paging occasion of the cell in the first RAT and a paging occasion of a cell in a second RAT; and
means for camping on a third RAT upon determining that the paging occasions overlap.

16. The apparatus of claim 15, further comprising:
means for detecting a paging occasion change on at least one of the cell in the first RAT and the cell in the second RAT while camping on the third RAT.

17. The apparatus of claim 16, further comprising:
means for returning to the first RAT after determining the paging occasions of the first and second RATs do not overlap.

18. The apparatus of claim 15, further comprising:
means for determining a paging cycle value of the first RAT and the second RAT; and
means for camping on the third RAT when the paging cycle value is less than a threshold value.

19. The apparatus of claim 15, further comprising:
means for returning to camping on the first RAT based on a trigger, in which the trigger is one of a timer, a release of a radio connection, and a serving cell change.

20. The apparatus of claim 15, wherein determining that the paging occasions of the first and second RATs overlap comprises:
determining a page in the first RAT will be missed due to tuning away to the second RAT.

21. The apparatus of claim 20, further comprising:
means for performing a cell reselection in the first RAT after determining that the paging occasions of the first and second RATs overlap;
means for detecting a paging occasion of the reselected cell in the first RAT; and
means for camping on the third RAT when the paging occasion of the reselected cell in the first RAT and the paging occasion of the second RAT overlap.

22. The apparatus of claim 21, wherein the cell reselection selects a neighboring cell in the first RAT.

23. The apparatus of claim 21, wherein the cell reselection selects a cell from one of a same Public Land Mobile Network (PLMN) or an equivalent PLMN as the cell in the first RAT.

24. The apparatus of claim 21, further comprising:
means for entering a data optimized (DO) mode when another cell on the first RAT is not available and a ratio between paging cycles of the first and second RATs exceeds a threshold.

25. The apparatus of claim 15, further comprising:
means for prioritizing pages in the first RAT over pages in the second RAT based on downlink traffic.

26. The apparatus of claim 20, further comprising:
means for reducing tune-away to the second RAT using at least one of connected mode discontinuous reception (DRX) intervals and connected mode gaps on the first RAT for non-page reception activities in the second RAT.

27. The apparatus of claim 15, wherein the first RAT is a Long Term Evolution (LTE) network and the second RAT is a 1x network.

28. The apparatus of claim 27, wherein the third RAT is an evolved High Rate Packet Data (eHRPD) network.

29. An apparatus for wireless communication performed by a user equipment (UE), comprising:
at least one processor configured to:
camp on a cell in a first radio access technology (RAT);
detect a paging occasion of the cell in the first RAT and a paging occasion of a cell in a second RAT; and
camp on a third RAT upon determining that the paging occasions overlap; and
a memory coupled to the at least one processor.

30. The apparatus of claim 29, wherein the at least one processor is further configured to:
detect a paging occasion change on at least one of the cell in the first RAT and the cell in the second RAT while camping on the third RAT.

31. The apparatus of claim 30, wherein the at least one processor is further configured to:
return to the first RAT after determining the paging occasions of the first and second RATs do not overlap.

32. The apparatus of claim 29, wherein the at least one processor is further configured to:
determine a paging cycle value of the first RAT and the second RAT; and
camp on the third RAT when the paging cycle value is less than a threshold value.

33. The apparatus of claim 29, wherein the at least one processor is further configured to:
return to camping on the first RAT based on a trigger, in which the trigger is one of a timer, a release of a radio connection, and a serving cell change.

34. The apparatus of claim 29, wherein determining that the paging occasions of the first and second RATs overlap comprises:
determining a page in the first RAT will be missed due to tuning away to the second RAT.

35. The apparatus of claim 34, wherein the at least one processor is further configured to:
perform a cell reselection in the first RAT after determining that the paging occasions of the first and second RATs overlap;
detect a paging occasion of the reselected cell in the first RAT; and
camp on the third RAT when the paging occasion of the reselected cell in the first RAT and the paging occasion of the second RAT overlap.

36. The apparatus of claim 35, wherein the cell reselection selects a neighboring cell in the first RAT.

37. The apparatus of claim 35, wherein the cell reselection selects a cell from one of a same Public Land Mobile Network (PLMN) or an equivalent PLMN as the cell in the first RAT.

38. The apparatus of claim 35, wherein the at least one processor is further configured to:
enter a data optimized (DO) mode when another cell on the first RAT is not available and a ratio between paging cycles of the first and second RATs exceeds a threshold.

39. The apparatus of claim 29, wherein the at least one processor is further configured to:
prioritize pages in the first RAT over pages in the second RAT based on downlink traffic.

40. The apparatus of claim 34, wherein the at least one processor is further configured to:
reduce tune-away to the second RAT using at least one of connected mode discontinuous reception (DRX) intervals and connected mode gaps on the first RAT for non-page reception activities in the second RAT.

41. The apparatus of claim 29, wherein the first RAT is a Long Term Evolution (LTE) network and the second RAT is a 1x network.

42. The apparatus of claim 41, wherein the third RAT is an evolved High Rate Packet Data (eHRPD) network.

43. A computer-program product for wireless communication by a user equipment (UE), the computer-program product comprising a non-transitory computer-readable medium having code stored thereon, the code executable by one or more processors for:
camping on a cell in a first radio access technology (RAT);
detecting a paging occasion of the cell in the first RAT and a paging occasion of a cell in a second RAT; and
camping on a third RAT upon determining that the paging occasions overlap.

44. The computer-program product of claim 43, further comprising:
code for detecting a paging occasion change on at least one of the cell in the first RAT and the cell in the second RAT while camping on the third RAT.

45. The computer-program product of claim 44, further comprising:
code for returning to the first RAT after determining the paging occasions of the first and second RATs do not overlap.

46. The computer-program product of claim 43, further comprising:
code for determining a paging cycle value of the first RAT and the second RAT; and
code for camping on the third RAT when the paging cycle value is less than a threshold value.

47. The computer-program product of claim 43, further comprising:
code for returning to camping on the first RAT based on a trigger, in which the trigger is one of a timer, a release of a radio connection, and a serving cell change.

48. The computer-program product of claim 43, wherein determining that the paging occasions of the first and second RATs overlap comprises:
determining a page in the first RAT will be missed due to tuning away to the second RAT.

49. The computer-program product of claim 48, further comprising:
code for performing a cell reselection in the first RAT after determining that the paging occasions of the first and second RATs overlap;
code for detecting a paging occasion of the reselected cell in the first RAT; and
code for camping on the third RAT when the paging occasion of the reselected cell in the first RAT and the paging occasion of the second RAT overlap.

50. The computer-program product of claim 49, wherein the cell reselection selects a neighboring cell in the first RAT.

51. The computer-program product of claim 49, wherein the cell reselection selects a cell from one of a same Public Land Mobile Network (PLMN) or an equivalent PLMN as the cell in the first RAT.

52. The computer-program product of claim 47, further comprising:
code for entering a data optimized (DO) mode when another cell on the first RAT is not available and a ratio between paging cycles of the first and second RATs exceeds a threshold.

53. The computer-program product of claim 43, further comprising:
code for prioritizing pages in the first RAT over pages in the second RAT based on downlink traffic.

54. The computer-program product of claim 48, further comprising:
code for reducing tune-away to the second RAT using at least one of connected mode discontinuous reception (DRX) intervals and connected mode gaps on the first RAT for non-page reception activities in the second RAT.

55. The computer-program product of claim 43, wherein the first RAT is a Long Term Evolution (LTE) network and the second RAT is a 1x network.

56. The computer-program product of claim 55, wherein the third RAT is an evolved High Rate Packet Data (eHRPD) network.
